(19) United States
(12) Patent Application Publication
(10) Pub. No.: US 2025/0130584 A1
(43) Pub. Date: Apr. 24, 2025

(54) AUTONOMOUS MOBILE BODY

(71) Applicant: AISIN CORPORATION, Kariya (JP)

(72) Inventors: Masashi Nobutoki, Kariya-shi (JP); Shintaro Suzuki, Kariya-shi (JP); Tetsuhiro Maki, Kariya-shi (JP); Wataru Takayanagi, Kariya-shi (JP); Toshihiko Ishida, Kariya-shi (JP)

(73) Assignee: AISIN CORPORATION, Kariya (JP)

(21) Appl. No.: 18/920,097

(22) Filed: Oct. 18, 2024

(30) Foreign Application Priority Data
Oct. 23, 2023 (JP) 2023-181617
Feb. 19, 2024 (JP) 2024-022679

(51) Int. Cl. G05D 1/622; B62D 63/02; G06V 20/58

(52) U.S. Cl. CPC G05D 1/622; B62D 63/02; G06V 20/58

(57) ABSTRACT

An autonomous mobile body includes: a first unit including a drive wheel and a chassis and configured to move straight and turn and move left and right; a second unit disposed at an upper portion of the first unit and including a top plate and an oscillating mechanism for performing oscillating motion of moving around a vertical axis with reference to the first unit; an obstacle detection unit configured to detect a surrounding obstacle; and a control unit configured to, when the obstacle detection unit detects an obstacle in a traveling direction of the autonomous mobile body during movement of the autonomous mobile body, upon controlling the first unit to change the traveling direction of the autonomous mobile body to avoid the obstacle, control the second unit to perform oscillating motion before changing the traveling direction.

### CROSS REFERENCE TO RELATED APPLICATIONS

This application is based on and claims priority under 35 U.S.C. § 119 to Japanese Patent Application 2023-181617, filed on Oct. 23, 2023, and Japanese Patent Application 2024-022679, filed on Feb. 19, 2024, the entire content of which is incorporated herein by reference.

### TECHNICAL FIELD

This disclosure relates to an autonomous mobile body.

### BACKGROUND DISCUSSION

In the related art, research and development of autonomous traveling robots capable of transporting objects such as food and drink and luggage have been performed. When there is a person who is an obstacle in a traveling direction, the autonomous traveling robot, for example, decelerates or stops, predicts a traveling direction of the person, changes a traveling direction of the autonomous traveling robot to a direction different from the predicted traveling direction of the person, and passes by the person while maintaining a distance that does not cause collision with the person.

Examples of the related art include JP 5768273B (Reference 1).

However, in movement of the above-described autonomous traveling robot, there is a problem that the person cannot recognize a direction in which the autonomous traveling robot is changing a traveling direction until the autonomous traveling robot starts to change the traveling direction, making it difficult to respond.

On the other hand, in a case of a human, when there is another person in a traveling direction, a direction of a face (line of sight) may be changed before the traveling direction starts to be changed in order to avoid the other person. Accordingly, the other person can see the person who changes the direction of the face (line of sight) and recognize that the person is about to change the traveling direction and a direction of that change.

Thus, there is room for improvement in that the autonomous traveling robot in the related art is not yet able to move like a human when the traveling direction is changed.

A need thus exists for an autonomous mobile body which is not susceptible to the drawback mentioned above.

### SUMMARY

According to an aspect of this disclosure, an autonomous mobile body includes: a first unit including a drive wheel and a chassis and configured to move straight and turn and move left and right; a second unit disposed at an upper portion of the first unit and including a top plate and an oscillating mechanism for performing oscillating motion of moving around a vertical axis with reference to the first unit; an obstacle detection unit configured to detect a surrounding obstacle; and a control unit configured to, when the obstacle detection unit detects an obstacle in a traveling direction of the autonomous mobile body during movement of the autonomous mobile body, upon controlling the first unit to change the traveling direction of the autonomous mobile body to avoid the obstacle, control the second unit to perform oscillating motion before changing the traveling direction.

### BRIEF DESCRIPTION OF THE DRAWINGS

The foregoing and additional features and characteristics of this disclosure will become more apparent from the following detailed description considered with the reference to the accompanying drawings, wherein:

FIGS. 1A and 1B are diagrams showing a structure of an autonomous traveling robot according to an embodiment;

FIG. 2 is a diagram showing a functional configuration of the autonomous traveling robot according to the embodiment;

FIG. 3 is a diagram showing a first operation example of the autonomous traveling robot according to the embodiment;

FIG. 4 is a flowchart showing first processing executed by the autonomous traveling robot according to the embodiment;

FIG. 5 is a diagram showing a second operation example of the autonomous traveling robot according to the embodiment;

FIG. 6 is a diagram showing a third operation example of the autonomous traveling robot according to the embodiment; and

FIG. 7 is a flowchart showing second processing executed by the autonomous traveling robot according to the embodiment.

### DETAILED DESCRIPTION

Hereinafter, an autonomous traveling robot (autonomous mobile body) according to the present embodiment will be described with reference to the drawings. In the following description, “front-rear (direction)” indicates a direction parallel to a traveling direction of the autonomous traveling robot. “Left-right (direction)” is a direction perpendicular to the traveling direction of the autonomous traveling robot and parallel to a ground.

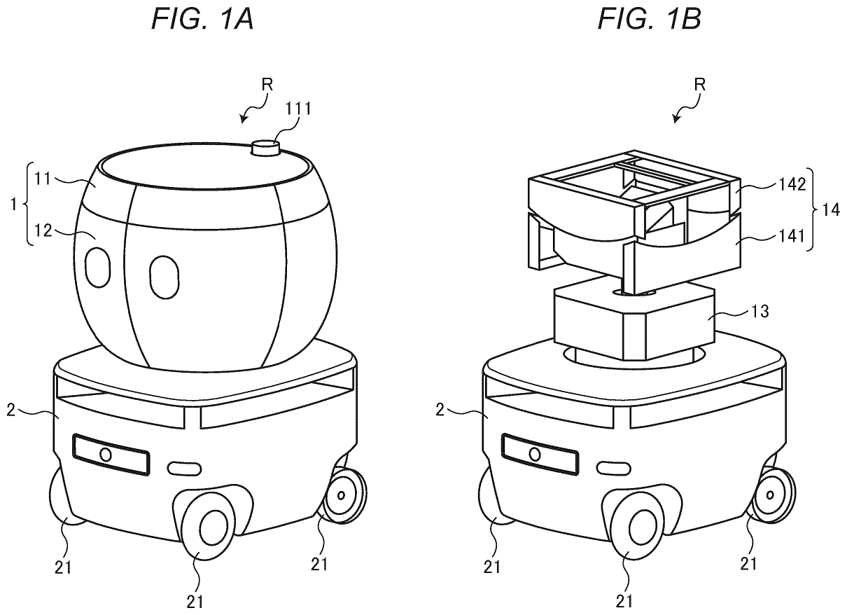

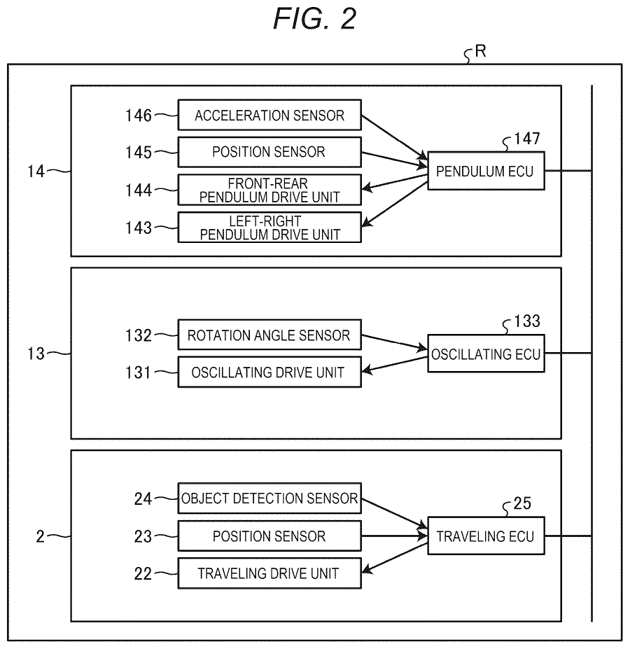

First, a structure and a functional configuration of an autonomous traveling robot R will be described with reference to FIGS. 1A to 2. FIGS. 1A and 1B are diagrams showing the structure of the autonomous traveling robot R according to the embodiment. FIG. 2 is a diagram showing the functional configuration of the autonomous traveling robot R according to the embodiment.

FIG. 1A is an external view of the autonomous traveling robot R. The autonomous traveling robot R can transport objects such as food and drink and luggage, and autonomously moves within a mobile environment such as a restaurant, a house, a facility, a warehouse, a factory, or an outdoor.

The autonomous traveling robot R includes a transport unit 1 (second unit) and a traveling unit 2. The traveling unit 2 has a substantially rectangular parallelepiped shape with rounded corners, has four drive wheels 21 and a chassis, and is capable of moving straight and turning and moving left and right.

The transport unit 1 has a barrel shape and is disposed at an upper portion of the traveling unit 2, and includes an upper body 11 and a lower body 12. A housing of the upper body 11 is fixed to a pendulum mechanism 14 (FIG. 1B) and moves in accordance with movement of the pendulum mechanism 14. A housing of the lower body 12 is fixed to a rotation mechanism 13 (FIG. 1B) and rotates in accordance with rotational movement of the rotation mechanism 13.

FIG. 1B is a diagram showing an internal structure of the transport unit 1 of the autonomous traveling robot R. That is, in FIG. 1B, a housing portion of the upper body 11 and a housing portion of the lower body 12 shown in FIG. 1A are not shown. The transport unit 1 includes the rotation mechanism 13 and the pendulum mechanism 14.

The rotation mechanism 13 is an oscillating mechanism for performing oscillating motion of moving around a vertical axis with reference to the traveling unit 2.

The pendulum mechanism 14 is a transport mechanism for transporting luggage, and includes a front-rear pendulum mechanism 141 and a left-right pendulum mechanism 142. The front-rear pendulum mechanism 141 is a pendulum mechanism for tilting an upper surface (top plate) of the upper body 11 in the front-rear direction. The left-right pendulum mechanism 142 is a pendulum mechanism for tilting the upper surface (top plate) of the upper body 11 in the left-right direction. An object transported by the autonomous traveling robot R is placed on the upper surface (top plate) of the upper body 11. A mark 111 is attached to the upper surface (top plate) of the upper body 11.

As shown in FIG. 2, the traveling unit 2 includes a traveling drive unit 22, a position sensor 23, an object detection sensor 24 (obstacle detection sensor), and a traveling ECU 25.

The traveling drive unit 22 includes an electric motor that rotationally drives the drive wheels 21.

The position sensor 23 is a sensor that acquires data for estimating a position of the autonomous traveling robot R by the traveling ECU 25. The position sensor 23 is implemented by, for example, a global positioning system (GPS) sensor and a rotation angular velocity sensor of the drive wheel 21, and transmits a detection signal to the traveling ECU 25.

The object detection sensor 24 is a sensor that detects an object (hereinafter, also referred to as an “obstacle”) around the autonomous traveling robot R. The object detection sensor 24 is implemented by, for example, a light detection and ranging (LiDAR) or a millimeter wave sensor, and transmits a detection signal to the traveling ECU 25. In addition, the object detection sensor 24 may be implemented by a camera, an ultrasonic sensor, an infrared sensor, or the like, or may be a combination of a plurality of units.

The traveling ECU 25 is an information processing device implemented using predetermined hardware and software, and is implemented using, for example, a central processing unit (CPU), a memory, a field programmable gate array (FPGA), and an application specific integrated circuit (ASIC).

The traveling ECU 25 executes various kinds of control. For example, the traveling ECU 25 estimates a current position of the autonomous traveling robot R based on a detection signal acquired from the position sensor 23. The traveling ECU 25 recognizes an obstacle around the autonomous traveling robot R based on a detection signal acquired from the object detection sensor 24. The traveling ECU 25 generates a travel route from a current position to a destination based on the current position, the destination, and a position of the obstacle. The traveling ECU 25 controls the traveling drive unit 22 to cause the traveling unit 2 (and thus the autonomous traveling robot R) to travel along the travel route.

The rotation mechanism 13 includes an oscillating drive unit 131, a rotation angle sensor 132, and an oscillating ECU 133 (control unit).

The oscillating drive unit 131 includes an actuator that rotationally moves the rotation mechanism 13.

The rotation angle sensor 132 is a sensor that detects a rotation angle of the rotation mechanism 13 and transmits a detection signal to the oscillating ECU 133.

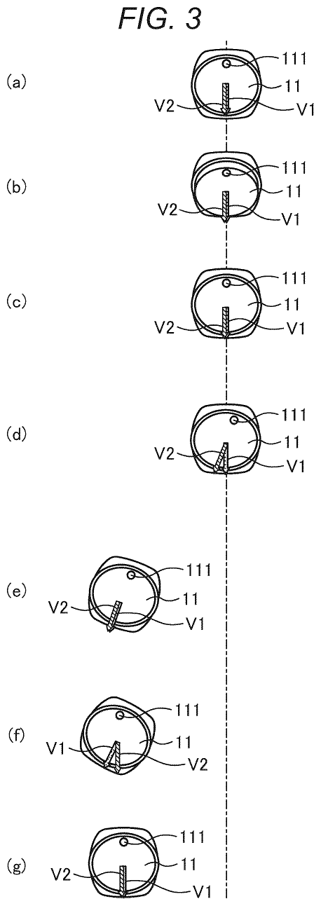

The oscillating ECU 133 executes various kinds of control. Hereinafter, a person is mainly assumed as an obstacle. Correspondence with FIG. 3 (details will be described later) is also shown.

When the traveling ECU 25 controls the traveling unit 2 to change a traveling direction of the autonomous traveling robot R in order to avoid the obstacle (person), the oscillating ECU 133 controls the transport unit 1 to perform oscillating motion ((d) in FIG. 3) before changing the traveling direction (between (d) and (e) in FIG. 3).

When the object detection sensor 24 detects the obstacle (person) in the traveling direction of the autonomous traveling robot R during movement of the autonomous traveling robot R, the oscillating ECU 133 may calculate a travel route for avoiding the obstacle (person) based on a predicted traveling direction of the obstacle (person) and a distance to the obstacle (person), cause the transport unit 1 to perform oscillating motion in the same direction as a direction in which the traveling direction is changed before changing the traveling direction, and control an angle of the oscillating motion of the transport unit 1 such that the angle (for example, 40 degrees) is larger than a maximum angle change amount (for example, 30 degrees) at which the traveling direction of the traveling unit 2 changes most greatly in the travel route.

When causing the transport unit 1 to perform a recognition operation for an obstacle (person) (an operation for letting the obstacle (person) know that the obstacle (person) is detected), the oscillating ECU 133 can control the oscillating drive unit 131 to cause the transport unit 1 to perform oscillating motion as the recognition operation. Specifically, when the object detection sensor 24 detects the obstacle (person) in the traveling direction of the autonomous traveling robot R during the movement of the autonomous traveling robot R, the oscillating ECU 133 controls the oscillating drive unit 131 to cause the transport unit 1 to perform the oscillating motion as a predetermined recognition operation.

In this case, the oscillating ECU 133 may perform different recognition operations according to a size of an obstacle (person) or the like. For example, if the obstacle (person) is an adult, the transport unit 1 is caused to perform small oscillating motion, and if the obstacle (person) is a child, the transport unit 1 is caused to perform large oscillating motion.

When causing the transport unit 1 to perform the recognition operation, the oscillating ECU 133 may cause the transport unit 1 to perform different recognition operations according to a distance between the autonomous traveling robot R and the obstacle (person) or a relative speed between the autonomous traveling robot R and the obstacle (person). For example, if the distance is equal to or longer than a threshold distance, the transport unit 1 is caused to perform small oscillating motion, and if the distance is shorter than the threshold distance, the transport unit 1 is caused to perform large oscillating motion.

When the object detection sensor 24 detects the obstacle (person) in the traveling direction of the autonomous traveling robot R during the movement of the autonomous traveling robot R, the oscillating ECU 133 may determine whether the obstacle (person) recognizes presence of the autonomous traveling robot R, and if it is determined that the obstacle (person) recognizes the presence of the autonomous traveling robot R, the oscillating ECU 133 may cause the transport unit 1 to perform a recognition operation. Whether the obstacle (person) recognizes the presence of the autonomous traveling robot R can be determined based on, for example, changes in walking speed, walking direction, and facial expression of the obstacle (person).

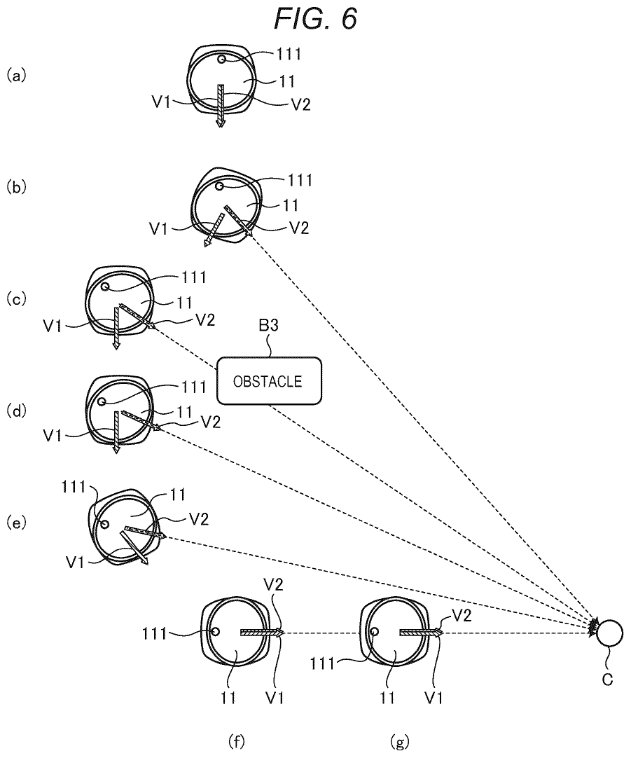

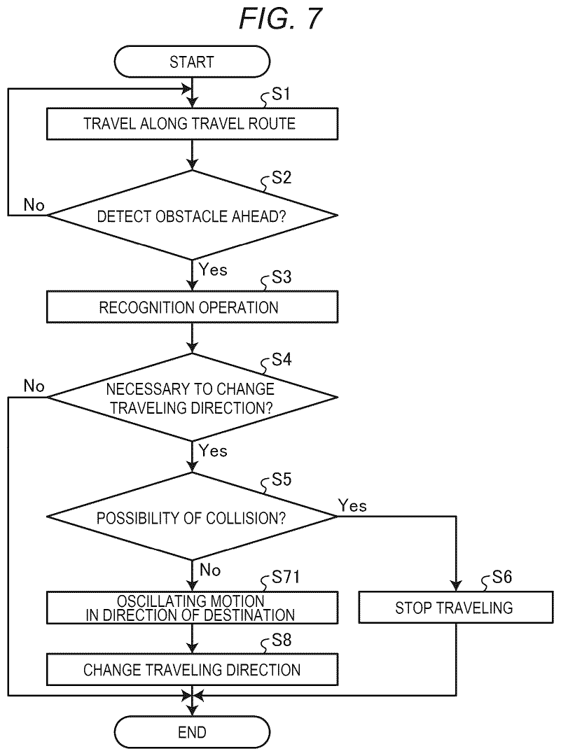

When changing the traveling direction of the autonomous traveling robot R by controlling the traveling unit 2 in order to avoid an obstacle (person), upon controlling the transport unit 1 to perform the oscillating motion before changing the traveling direction, the oscillating ECU 133 may control an angle of the oscillating motion of the transport unit 1 such that the transport unit 1 faces a destination until the autonomous traveling robot R arrives at the destination (details will be described later with reference to FIGS. 6 and 7).

As shown in FIG. 2, the pendulum mechanism 14 includes a left-right pendulum drive unit 143, a front-rear pendulum drive unit 144, a position sensor 145, an acceleration sensor 146, and a pendulum ECU 147.

When the autonomous traveling robot R turns and moves in the left-right direction, acceleration in the left-right direction occurs in the autonomous traveling robot R, the left-right pendulum drive unit 143 is a mechanism for causing the upper body 11 to perform pendulum motion in the left-right direction so as to cancel out an effect of the acceleration so that an object placed on the upper surface (top plate) of the upper body 11 does not fall in the left-right direction due to the effect of the acceleration. The left-right pendulum drive unit 143 corresponds to the left-right pendulum mechanism 142 in FIG. 1B. In addition to cancelling out the effect of the acceleration, the left-right pendulum drive unit 143 can cause the upper body 11 to perform pendulum motion in the left-right direction as a recognition operation.

When the autonomous traveling robot R accelerates or decelerates in the front-rear direction, acceleration in the front-rear direction occurs in the autonomous traveling robot R, the front-rear pendulum drive unit 144 is a mechanism for causing the upper body 11 to perform pendulum motion in the front-rear direction so as to cancel out an effect of the acceleration so that an object placed on the upper surface (top plate) of the upper body 11 does not fall in the front-rear direction due to the effect of the acceleration. The front-rear pendulum drive unit 144 corresponds to the front-rear pendulum mechanism 141 in FIG. 1B. In addition to cancelling out the effect of the acceleration, the front-rear pendulum drive unit 144 can cause the upper body 11 to perform pendulum motion in the front-rear direction as a recognition operation.

The left-right pendulum drive unit 143 and the front-rear pendulum drive unit 144 can be controlled in parallel. Accordingly, regardless of a direction in which acceleration occurs within 360 degrees around the autonomous traveling robot R, by controlling the left-right pendulum drive unit 143 and the front-rear pendulum drive unit 144 in parallel so as to cancel out the effect of the acceleration, it is possible to prevent an object placed on the upper surface (top plate) of the upper body 11 from falling. The left-right pendulum drive unit 143 and the front-rear pendulum drive unit 144 may be controlled in parallel to operate the upper body 11 as a recognition operation.

The position sensor 145 is a sensor that acquires data for estimating a position of the pendulum mechanism 14. The position sensor 145 is implemented by, for example, a rotation angular velocity sensor, and transmits a detection signal to the pendulum ECU 147. The position sensor 145 may be provided for each of the front-rear pendulum mechanism 141 and the left-right pendulum mechanism 142.

The acceleration sensor 146 detects acceleration occurred in the pendulum mechanism 14 and transmits a detection signal to the pendulum ECU 147.

The pendulum ECU 147 executes various kinds of control. Based on the detection signals acquired from the position sensor 145 and the acceleration sensor 146, the pendulum ECU 147 controls the left-right pendulum drive unit 143 and the front-rear pendulum drive unit 144 to cause the upper body 11 to perform pendulum motion so that an object placed on the upper surface (top plate) of the upper body 11 does not fall due to the acceleration occurred in the autonomous traveling robot R.

The pendulum ECU 147 controls the left-right pendulum drive unit 143 and the front-rear pendulum drive unit 144 to cause the upper body 11 to perform pendulum motion as a recognition operation.

For example, when the object detection sensor 24 detects an obstacle (person) in the traveling direction of the autonomous traveling robot R during the movement of the autonomous traveling robot R, the pendulum ECU 147 controls the front-rear pendulum drive unit 144 to cause the upper body 11 to perform pendulum motion as a predetermined recognition operation ((b) in FIG. 3). The pendulum ECU 147 may cause the upper body 11 to perform pendulum motion in the front-rear direction if the obstacle (person) is an adult, and may cause the upper body 11 to perform pendulum motion in the left-right direction if the obstacle (person) is a child.

By causing the autonomous traveling robot R to perform an operation that is not normally performed as a recognition operation, it is possible to let an obstacle (person) who sees the autonomous traveling robot R know that the autonomous traveling robot R recognizes the obstacle (person). That is, the recognition operation corresponds to communication methods between people, such as eye contact and nodding.

Next, a first operation example of the autonomous traveling robot R will be described in detail with reference to FIG. 3. The traveling ECU 25, the oscillating ECU 133, and the pendulum ECU 147 can communicate with each other via a controller area network (CAN) or the like, and transmit and receive necessary information.

FIG. 3 is a diagram showing the first operation example of the autonomous traveling robot R according to the embodiment. Here, a premise of FIG. 3 will be described. As described above, in general, when there is a person who is an obstacle in the traveling direction, the autonomous traveling robot, for example, decelerates or stops, predicts a traveling direction of the person, changes a traveling direction of the autonomous traveling robot to a direction different from the predicted traveling direction of the person, and passes by the person while maintaining a distance that does not cause collision with the person.

However, in movement of the autonomous traveling robot, there is a problem that the person cannot recognize a direction in which the autonomous traveling robot is changing a traveling direction until the autonomous traveling robot starts to change the traveling direction, making it difficult to respond.

On the other hand, in a case of a human, when there is another person in the traveling direction, a direction of a face (line of sight) may be changed before a traveling direction starts to be changed in order to avoid the other person. Accordingly, the other person can see the person who changes the direction of the face (line of sight) and recognize that the person is about to change the traveling direction and a direction of that change.

Thus, there is room for improvement in that the autonomous traveling robot in the related art is not yet able to move like a human. Therefore, in FIG. 3, a case will be described where, when there is a person who is an obstacle is present in a traveling direction of the autonomous traveling robot R, the person is made to recognize at an early stage a direction in which the autonomous traveling robot R changes the traveling direction.

In the example in FIG. 3, it is assumed that the autonomous traveling robot R is initially moving straight. Although a recognition operation can be performed by either the oscillating ECU 133 or the pendulum ECU 147, a case where the recognition operation is performed by the pendulum ECU 147 will be described below as an example. In (a) to (g) in FIG. 3, a direction V1 indicates a direction in which (a front surface of) the traveling unit 2 faces. A direction V2 indicates a direction in which (a front surface of) the transport unit 1 faces.

In (a) in FIG. 3, it is assumed that the autonomous traveling robot R is moving straight and the object detection sensor 24 detects an obstacle (person) ahead.

Then, next, in (b) in FIG. 3, the pendulum ECU 147 controls the front-rear pendulum drive unit 144 to perform a recognition operation in order to cause the obstacle (person) to recognize that the autonomous traveling robot R detects the obstacle (person). Specifically, the upper body 11 performs pendulum motion in the front-rear direction such that a front side is lowered and a rear side is raised. The recognition operation is not limited thereto, and the transport unit 1 may be allowed to perform oscillating motion in a predetermined direction.

Next, in (c) in FIG. 3, the pendulum ECU 147 controls the front-rear pendulum drive unit 144 to perform pendulum motion to cause the upper body 11 to return to an original position. At this time, the traveling ECU 25 determines to change the traveling direction to a right side (left side in FIG. 3) with reference to the traveling direction in order to avoid collision with the obstacle (person).

Then, before the traveling unit 2 (autonomous traveling robot R) changes the traveling direction (between (d) and (e) in FIG. 3), in (d) in FIG. 3, the oscillating ECU 133 controls the transport unit 1 to perform oscillating motion in the same direction as a direction in which the traveling direction is changed.

Thereafter, the traveling unit 2 (autonomous traveling robot R) changes the traveling direction under control of the traveling drive unit 22 by the traveling ECU 25 between (d) and (e) in FIG. 3. At a time point in (e) in FIG. 3, the direction V1 and the direction V2 are aligned.

Thereafter, it is assumed that the autonomous traveling robot R and the obstacle (person) pass each other between (e) and (f) in FIG. 3. Then, immediately thereafter, the traveling unit 2 (the autonomous traveling robot R) changes the traveling direction under control of the traveling drive unit 22 by the traveling ECU 25. At a time point in (f) in FIG. 3, the traveling direction (the direction V2) of the autonomous traveling robot R becomes the same as an original direction ((a) in FIG. 3).

Thereafter, the oscillating ECU 133 controls the oscillating drive unit 131 to cause the transport unit 1 to perform oscillating motion so that the direction (direction V1) of the transport unit 1 is aligned with the traveling direction (direction V2) of the autonomous traveling robot R. Accordingly, the direction V1 and the direction V2 are aligned at a time point in (g) in FIG. 3. The travel route in a straight direction in (g) in FIG. 3 and thereafter may or may not coincide with a travel route in a straight direction at a time point in (a) in FIG. 3.

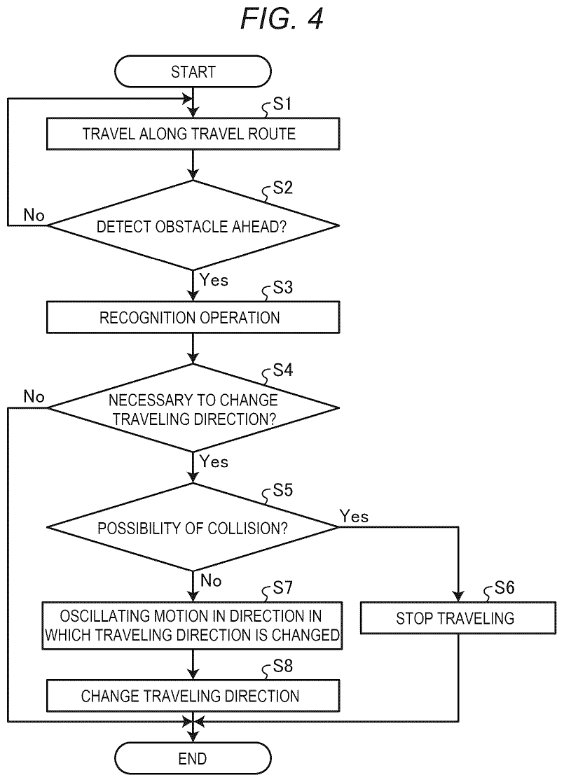

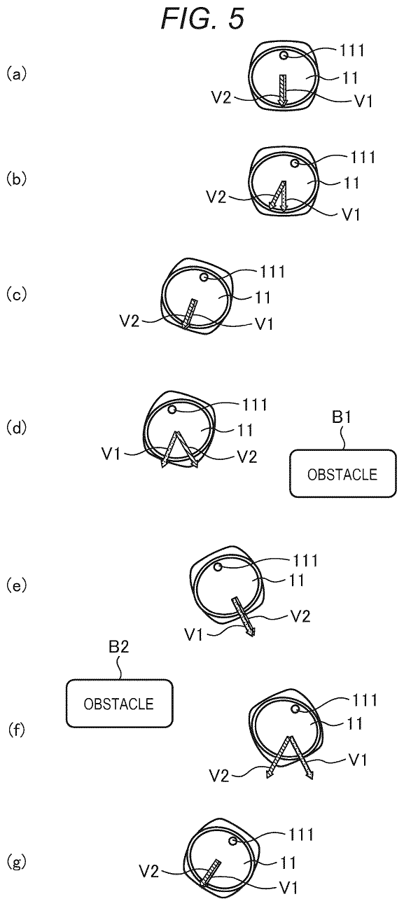

Next, first processing executed by the autonomous traveling robot R will be described with reference to FIG. 4. FIG. 4 corresponds to FIGS. 3 and 5, and is a flowchart showing the first processing executed by the autonomous traveling robot R according to the embodiment. It is assumed that at a time point before this processing, the traveling ECU 25 generates a straight travel route from a current position to a destination based on the current position of the autonomous traveling robot R and the destination.

In step S1, the traveling ECU 25 controls the traveling drive unit 22 to cause the autonomous traveling robot R to travel (straight) along the travel route.

Next, in step S2, the traveling ECU 25 determines whether an obstacle (person) is detected ahead by the object detection sensor 24, and in a case of Yes, proceeds to step S3, and in a case of No, returns to step S1.

In step S3, the pendulum ECU 147 controls the front-rear pendulum drive unit 144 to perform a recognition operation ((b) in FIG. 3).

Next, in step S4, the traveling ECU 25 determines whether it is necessary to change a traveling direction of the autonomous traveling robot R in order to avoid collision with the obstacle (person), and in a case of Yes, proceeds to step S5, and in a case of No, ends the processing (continue traveling).

In step S5, the traveling ECU 25 determines whether there is a possibility of collision with the obstacle (person), and in a case of Yes, proceeds to step S6, and in a case of No, proceeds to step S7.

In step S6, the traveling ECU 25 controls the traveling drive unit 22 to stop traveling.

In step S7, the oscillating ECU 133 controls the oscillating drive unit 131 to cause the transport unit 1 to perform oscillating motion in the same direction as a direction in which the traveling direction is changed ((d) in FIG. 3).

Next, in step S8, the traveling ECU 25 controls the traveling drive unit 22 to change the traveling direction of the autonomous traveling robot R (between (d) and (e) in FIG. 3).

Next, a second operation example of the autonomous traveling robot R will be described with reference to FIG. 5. FIG. 5 is a diagram showing the second operation example of the autonomous traveling robot R according to the embodiment. In the example in FIG. 5, it is assumed that the autonomous traveling robot R first moves straight and then sequentially avoids two obstacles. Similar matters as those in FIG. 3 will not be described repeatedly.

In (a) in FIG. 5, it is assumed that the autonomous traveling robot R is moving straight and the object detection sensor 24 detects an obstacle B1 (person) ahead. A recognition operation is similar as that in FIG. 3, and illustration and description thereof in FIG. 5 are omitted. At this time, the traveling ECU 25 determines to change a traveling direction to a right side (left side in FIG. 5) with reference to the traveling direction in order to avoid collision with the obstacle B1 (person).

Then, before the traveling unit 2 (autonomous traveling robot R) changes the traveling direction (between (b) and (c) in FIG. 5), in (b) in FIG. 5, the oscillating ECU 133 controls the transport unit 1 to perform oscillating motion in the same direction as a direction in which the traveling direction is changed.

Thereafter, the traveling unit 2 (autonomous traveling robot R) changes the traveling direction under control of the traveling drive unit 22 by the traveling ECU 25 between (b) and (c) in FIG. 5, and at a time point in (c) in FIG. 5, the direction V1 and the direction V2 are aligned.

Thereafter, the autonomous traveling robot R and the obstacle (person) pass each other between (c) and (d) in FIG. 5. It is assumed that the object detection sensor 24 detects an obstacle B2 (person) ahead. At this time, the traveling ECU 25 determines to change the traveling direction to a left side (right side in FIG. 5) with reference to the traveling direction in order to avoid collision with the obstacle B2 (person).

Then, before the traveling unit 2 (autonomous traveling robot R) changes the traveling direction (between (d) and (e) in FIG. 5), in (d) in FIG. 5, the oscillating ECU 133 controls the transport unit 1 to perform oscillating motion in the same direction as a direction in which the traveling direction is changed.

Thereafter, the traveling unit 2 (autonomous traveling robot R) changes the traveling direction under control of the traveling drive unit 22 by the traveling ECU 25 between (d) and (e) in FIG. 5, and at a time point in (e) in FIG. 5, the direction V1 and the direction V2 are aligned.

Thereafter, the autonomous traveling robot R and the obstacle (person) B2 pass each other between (e) and (f) in FIG. 5. Here, the traveling ECU 25 determines to change the traveling direction to the right side (left side in FIG. 5) with reference to the traveling direction.

Then, before the traveling unit 2 (autonomous traveling robot R) changes the traveling direction (between (f) and (g) in FIG. 5), in (f) in FIG. 5, the oscillating ECU 133 controls the transport unit 1 to perform oscillating motion in the same direction as a direction in which the traveling direction is changed.

Thereafter, the traveling unit 2 (autonomous traveling robot R) changes the traveling direction under control of the traveling drive unit 22 by the traveling ECU 25 between (f) and (g) in FIG. 5, and at a time point in (g) in FIG. 5, the direction V1 and the direction V2 are aligned.

Next, a third operation example of the autonomous traveling robot R will be described with reference to FIG. 6. FIG. 6 is a diagram showing the third operation example of the autonomous traveling robot R according to the embodiment. In general, for example, when an employee at a restaurant carries food and drink, even if a traveling direction of the employee is different from a direction to a target customer at a certain moment, a face (line of sight) may be turned to the customer. Accordingly, the target customer can see the employee whose face (line of sight) is turned to him or her and recognize that the employee is facing a place of the customer.

However, the autonomous traveling robot in the related art only travels along a calculated route, and does not perform an operation equivalent to the operation of turning the face (line of sight) to the customer at the destination, as the employee described above does. Accordingly, even when the autonomous traveling robot is facing a place of the target customer, the customer cannot recognize that the autonomous traveling robot is facing the place of customer until a traveling direction of the autonomous traveling robot matches a direction toward the customer.

Therefore, in FIG. 6, a case will be described in which, when the autonomous traveling robot R is facing a target person C, the person C is caused to recognize that the autonomous traveling robot R is facing a place of the person C even before the traveling direction of the autonomous traveling robot matches a direction toward the person C. Similar matters as those in FIG. 3 will not be described repeatedly.

In (a) in FIG. 6, it is assumed that the autonomous traveling robot R is moving straight and the object detection sensor 24 detects an obstacle B3 ahead. At this time, the traveling ECU 25 determines to change a traveling direction to a right side (left side in FIG. 6) with reference to the traveling direction in order to avoid collision with the obstacle B3.

Then, the traveling unit 2 (autonomous traveling robot R) travels while changing the traveling direction so as to avoid collision with the obstacle B3 ((b) to (g)). During (b) to (g), the oscillating ECU 133 controls an angle of the oscillating motion of the transport unit 1 such that the transport unit 1 faces the direction of the destination (person C) from before the traveling direction of the autonomous traveling robot R changes until the autonomous traveling robot R arrives at the destination (person C).

Next, second processing executed by the autonomous traveling robot R will be described with reference to FIG. 7. FIG. 7 corresponds to FIG. 6, and is a flowchart showing the second processing executed by the autonomous traveling robot R according to the embodiment.

In comparison with FIG. 4, the processing is the same except that step S7 is replaced by step S71, so only step S71 will be described. In the case of No in step S5, in step S71, the oscillating ECU 133 controls the angle of the oscillating motion of the transport unit 1 such that the transport unit 1 faces the direction of the destination (person C in FIG. 6) ((b) to (g) in FIG. 6).

Thus, according to the autonomous traveling robot R in the present embodiment, when an obstacle (person) is detected in the traveling direction while the autonomous traveling robot R is moving, upon changing the traveling direction in order to avoid the obstacle (person), the transport unit 1 is caused to perform oscillating motion before the traveling direction is changed.

In this case, for example, before the autonomous traveling robot R changes the traveling direction, the transport unit 1 is caused to perform oscillating motion in the same direction as the direction in which the traveling direction is changed. Accordingly, when there is an obstacle (person) in the traveling direction of the autonomous traveling robot R, the obstacle (person) can recognize at an early stage the direction in which the autonomous traveling robot R changes the traveling direction. Therefore, safety of the obstacle (person) passing by the autonomous traveling robot R can be ensured, and the obstacle (person) can be given a sense of security.

When the autonomous traveling robot R causes the transport unit 1 to perform the oscillating motion in the same direction as the direction in which the traveling direction is changed before the autonomous traveling robot R changes the traveling direction, the angle of the oscillating motion of the transport unit 1 may be controlled to be an angle larger than a maximum angle change amount at which the traveling direction of the traveling unit 2 changes most greatly in the travel route. Accordingly, it is possible to further increase a possibility that the obstacle (person) notices the oscillating motion of the autonomous traveling robot R.

When the transport unit 1 is caused to perform the recognition operation, different recognition operations may be performed according to a size of an obstacle (person) or the like. Accordingly, for example, it is possible to implement a recognition operation that is more easily noticed for each obstacle (person).

When the transport unit 1 is caused to perform the recognition operation, the transport unit 1 may be caused to perform different recognition operations according to a distance between the autonomous traveling robot R and the obstacle (person) or a relative speed between the autonomous traveling robot R and the obstacle (person). Accordingly, for example, it is possible to implement the recognition operation for each distance according to importance of the recognition operation that can change according to the distance or the relative speed.

When the obstacle (person) is detected in the traveling direction of the autonomous traveling robot R, it may be determined whether the obstacle (person) recognizes presence of the autonomous traveling robot R, and if it is determined that the obstacle (person) recognizes the presence of the autonomous traveling robot R, the transport unit 1 may be caused to perform a recognition operation. Accordingly, an effective recognition operation can be achieved.

As shown in FIG. 5, even when the autonomous traveling robot R moves in an S-shape in order to sequentially avoid a plurality of obstacles, the transport unit 1 is caused to perform oscillating motion in the same direction as the direction in which the traveling direction is changed before the traveling direction is changed for each obstacle (person). Accordingly, the direction in which the autonomous traveling robot R changes the traveling direction can be recognized at an early stage for each obstacle (person).

As shown in FIG. 6, when changing the traveling direction of the autonomous traveling robot R by controlling the traveling unit 2 in order to avoid the obstacle B3, upon controlling the transport unit 1 to perform oscillating motion before changing the traveling direction, an angle of the oscillating motion of the transport unit 1 may be controlled such that the transport unit 1 faces a direction of destination (person C) until the autonomous traveling robot R arrives at the destination (person C). Accordingly, the person C can recognize that the autonomous traveling robot R is facing a place of the person C even before the traveling direction of the autonomous traveling robot R matches the direction toward the person C ((b) to (e) in FIG. 6).

A program executed by the autonomous traveling robot R in the present embodiment can be provided in a form of an installable or executable file recorded on a recording medium readable by a computer device, such as a compact disc (CD)-read only memory (ROM), a flexible disk (FD), a CD-recordable (R), or a digital versatile disk (DVD). The program may be provided or distributed via a network such as the Internet.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

For example, the acceleration sensor 146 may be provided not in the pendulum mechanism 14 but in the traveling unit 2. In this case, the acceleration sensor 146 does not detect acceleration due to pendulum motion by the pendulum mechanism 14 or rotational motion by the rotation mechanism 13, but the pendulum ECU 147 can determine control contents for the left-right pendulum drive unit 143 and the front-rear pendulum drive unit 144 by using not only a detection signal from the acceleration sensor 146, but also previous control signals from the pendulum ECU 147 to the left-right pendulum drive unit 143 and the front-rear pendulum drive unit 144, and a previous control signal from the oscillating ECU 133 to the oscillating drive unit 131.

On the other hand, as in the above-described embodiment, when the acceleration sensor 146 is provided in the pendulum mechanism 14, the acceleration sensor 146 detects acceleration due to pendulum motion by the pendulum mechanism 14 or rotational motion by the rotation mechanism 13, and thus such complicated processing is unnecessary. That is, control contents for the left-right pendulum drive unit 143 and the front-rear pendulum drive unit 144 can be determined by simple processing based only on the detection signal from the acceleration sensor 146.

This disclosure can be widely applied to autonomous mobile bodies in general other than the autonomous traveling robot.

In step S6 in FIG. 4, the autonomous traveling robot R may be decelerated first, and if there is still a possibility of collision with an obstacle (person), the traveling may be stopped.

According to an aspect of this disclosure, an autonomous mobile body includes: a first unit including a drive wheel and a chassis and configured to move straight and turn and move left and right; a second unit disposed at an upper portion of the first unit and including a top plate and an oscillating mechanism for performing oscillating motion of moving around a vertical axis with reference to the first unit; an obstacle detection unit configured to detect a surrounding obstacle; and a control unit configured to, when the obstacle detection unit detects an obstacle in a traveling direction of the autonomous mobile body during movement of the autonomous mobile body, upon controlling the first unit to change the traveling direction of the autonomous mobile body to avoid the obstacle, control the second unit to perform oscillating motion before changing the traveling direction.

According to this disclosure, it is possible to provide the autonomous mobile body that can move in a manner similar to that of a human when changing a traveling direction.

What is claimed is:

1. An autonomous mobile body comprising:
a first unit including a drive wheel and a chassis and configured to move straight and turn and move left and right;
a second unit disposed at an upper portion of the first unit and including a top plate and an oscillating mechanism for performing oscillating motion of moving around a vertical axis with reference to the first unit;
an obstacle detection unit configured to detect a surrounding obstacle; and
a control unit configured to, when the obstacle detection unit detects an obstacle in a traveling direction of the autonomous mobile body during movement of the autonomous mobile body, upon controlling the first unit to change the traveling direction of the autonomous mobile body to avoid the obstacle, control the second unit to perform oscillating motion before changing the traveling direction.

2. The autonomous mobile body according to claim 1, wherein
when the obstacle detection unit detects an obstacle in the traveling direction of the autonomous mobile body during the movement of the autonomous mobile body, the control unit calculates a travel route for avoiding the obstacle based on a predicted traveling direction of the obstacle and a distance to the obstacle, causes the second unit to perform oscillating motion in the same direction as a direction in which the traveling direction is changed before changing the traveling direction, and controls an angle of the oscillating motion of the second unit such that the angle is larger than a maximum angle change amount at which the traveling direction of the first unit changes most greatly in the travel route.

3. The autonomous mobile body according to claim 1, wherein
the control unit causes the second unit to perform a different recognition operation according to the obstacle when causing the second unit to perform a predetermined recognition operation.

4. The autonomous mobile body according to claim 1, wherein
when causing the second unit to perform a predetermined recognition operation, the control unit causes the second unit to perform a different recognition operation according to a distance between the autonomous mobile body and the obstacle or a relative speed between the autonomous mobile body and the obstacle.

5. The autonomous mobile body according to claim 1, wherein
when the obstacle detection unit detects an obstacle in the traveling direction of the autonomous mobile body during the movement of the autonomous mobile body, the control unit determines whether the obstacle recognizes presence of the autonomous mobile body, and if the control unit determines that the obstacle recognizes the presence of the autonomous mobile body, the control unit causes the second unit to perform a predetermined recognition operation.

6. The autonomous mobile body according to claim 1, wherein
when controlling the first unit to change the traveling direction of the autonomous mobile body to avoid the obstacle, upon controlling the second unit to perform the oscillating motion before changing the traveling direction, the control unit controls an angle of the oscillating motion of the second unit such that the second unit faces a direction of the destination until the autonomous mobile body arrives at the destination.
